(19) United States
(12) Patent Application Publication
(10) Pub. No.: US 2026/0184296 A1
(43) Pub. Date: Jul. 2, 2026

(54) CONTROL DEVICE, CONTROL METHOD, NON-TRANSITORY COMPUTER READABLE STORAGE MEDIUM STORING COMPUTER PROGRAM

(71) Applicant: DENSO CORPORATION, Kariya-city (JP)

(72) Inventors: Yoshinori TAKEUCHI, Kariya-city (JP); Teiyu KIMURA, Kariya-city (JP); Kazuki IZUMI, Kariya-city (JP)

(21) Appl. No.: 19/549,350

(22) Filed: Feb. 25, 2026

Related U.S. Application Data
(63) Continuation of application No. PCT/JP2024/030273, filed on Aug. 26, 2024.

(30) Foreign Application Priority Data
Aug. 29, 2023 (JP) 2023-139335

(51) Int. Cl. B60W 10/20; B60W 40/08; B60W 50/14; B60W 60/00

(52) U.S. Cl. CPC B60W 10/20; B60W 40/08; B60W 50/14; B60W 60/00253; B60W 2040/0881; B60W 2300/10; B60W 2540/18; B60W 2540/227; B60W 2556/45

(57) ABSTRACT

A steering of a vehicle is controlled by acquiring a steering angle of the steering during the autonomous driving, and when the vehicle is autonomously stopped under a stop control at a boarding area and a stop steering angle of the steering after the stop control completes falls outside an allowable angle range including the steering angle when the vehicle travels straight, performing a reset control for the steering to return the stop steering angle to a specified steering angle within the allowable angle range. A linkage between the steering and a tire is disconnected when performing the reset control.

### CROSS REFERENCE TO RELATED APPLICATIONS

The present application is a continuation application of International Patent Application No. PCT/JP2024/030273 filed on Aug. 26, 2024, which designated the U.S. and claims the benefit of priority from Japanese Patent Application No. 2023-139335 filed on Aug. 29, 2023. The entire disclosures of all the above applications are incorporated herein by reference.

### TECHNICAL FIELD

The present disclosure relates to control technology for controlling a steering of a vehicle configured to perform autonomous driving.

### BACKGROUND ART

There is a controller configured to control autonomous driving with a steering wheel rotating in conjunction with turning wheels.

### SUMMARY

A control device is configured to control a steering of a vehicle that is configured to perform autonomous driving. The control device includes a processor which may be configured to: acquire a steering angle of the steering during the autonomous driving; and when the vehicle is autonomously stopped under a stop control at a boarding area and a stop steering angle of the steering after the stop control completes falls outside an allowable angle range including the steering angle when the vehicle travels straight, perform a reset control for the steering to return the stop steering angle to a specified steering angle within the allowable angle range. The processor may be further configured to disconnect a linkage between the steering and a tire when performing the reset control.

### BRIEF DESCRIPTION OF DRAWINGS

FIG. 1 is a block diagram showing the overall configuration of a first embodiment.

FIG. 2 is a schematic diagram showing an example of a steering system controlled by a control device of the first embodiment.

FIG. 3 is a block diagram showing the functional configuration of the control device according to the first embodiment.

FIG. 4 is a flowchart showing a control flow when the vehicle stops according to the first embodiment.

FIG. 5 is a flowchart showing a control flow when the vehicle starts according to the first embodiment.

FIG. 6 is a flowchart showing a control flow when the vehicle starts according to a second embodiment.

FIG. 7 is a schematic diagram for explaining a reduced-ratio connected control according to the second embodiment.

FIG. 8 is a flowchart showing a control flow when the vehicle stops according to a third embodiment.

FIG. 9 is a flowchart showing a control flow when the vehicle stops according to a fourth embodiment.

### DESCRIPTION OF EMBODIMENTS

To begin with, examples of relevant techniques will be described.

There is a controller configured to control autonomous driving, in which the vehicle travels without being operated by a driver. The autonomous driving by the controller has a connected system, in which a steering wheel rotates in conjunction with turning wheels when the turning wheels are turned during autonomous driving.

In an autonomous vehicle in which a steering operates in conjunction with turning of tires during autonomous driving, the vehicle may stop while the steering remains at a steering angle deviating from the angle corresponding to the straight-ahead direction of the vehicle. In this situation, a user boarding the vehicle may feel a sense of discomfort regarding the steering angle of the steering before the vehicle starts under autonomous driving. Even when a user who has boarded the vehicle starts the vehicle in manual driving mode, the user may feel a sense of discomfort regarding the steering angle of the steering before starting the vehicle in manual driving.

The present disclosure provides a control device that reduces a user's sense of discomfort regarding the steering. The present disclosure also provides a control method for reducing a user's sense of discomfort regarding the steering. The present disclosure also provides a non-transitory computer readable storage medium storing a control program for reducing a user's sense of discomfort regarding the steering.

A first aspect of the present disclosure is a control device configured to control a steering of a vehicle that is configured to perform autonomous driving. The control device includes a processor configured to acquire a steering angle of the steering during the autonomous driving. When the vehicle is autonomously stopped under a stop control at a boarding area and a stop steering angle of the steering when the stop control completes falls outside an allowable angle range including the steering angle when the vehicle travels straight, the processor is configured to perform a reset control for the steering to return the stop steering angle to a specified steering angle within the allowable angle range.

A second aspect of the present disclosure is a control method, executed by a processor, for controlling a steering of a vehicle that is configured to perform autonomous driving. The method includes acquiring a steering angle of the steering during the autonomous driving. When the vehicle is autonomously stopped under a stop control at a boarding area and a stop steering angle of the steering when the stop control completes falls outside an allowable angle range including the steering angle when the vehicle travels straight, performing a reset control for the steering to return the stop steering angle to a specified steering angle within the allowable angle range.

A third aspect of the present disclosure is a computer readable non-transitory storage medium comprising a control program including instructions, when executed by a processor, to cause the processor to acquire a steering angle of the steering during the autonomous driving. When the vehicle is autonomously stopped under a stop control at a boarding area and a stop steering angle of the steering when the stop control completes falls outside an allowable angle range including the steering angle when the vehicle travels straight, the control program causes the processor to perform a reset control for the steering to return the stop steering angle to a specified steering angle within the allowable angle range.

According to these first to third embodiments, the steering is controlled so that the stop steering angle at completion of the stop control of the vehicle at the boarding area, where a user is expected to board on the vehicle, falls within an allowable angle range including a steering angle corresponding to the straight-ahead direction of the vehicle. Accordingly, the vehicle starts with the steering in the reset state within the allowable angle range for the user who has boarded the vehicle. Thus, any sense of discomfort experienced by the user regarding the steering can be suppressed.

Hereinafter, several embodiments of the present disclosure will be described with reference to the drawings. In the respective embodiments, corresponding components are denoted by the same reference numerals, and redundant descriptions may be omitted. Further, in cases where only a part of a configuration is described in each embodiment, the other parts of the configuration may be applied using the configurations described in the preceding embodiments. Furthermore, in the descriptions of each embodiment, not only the explicitly stated combinations of configurations, but also, unless there is a specific impediment to such combinations, portions of the configurations of multiple embodiments may be partially combined even if not expressly stated.

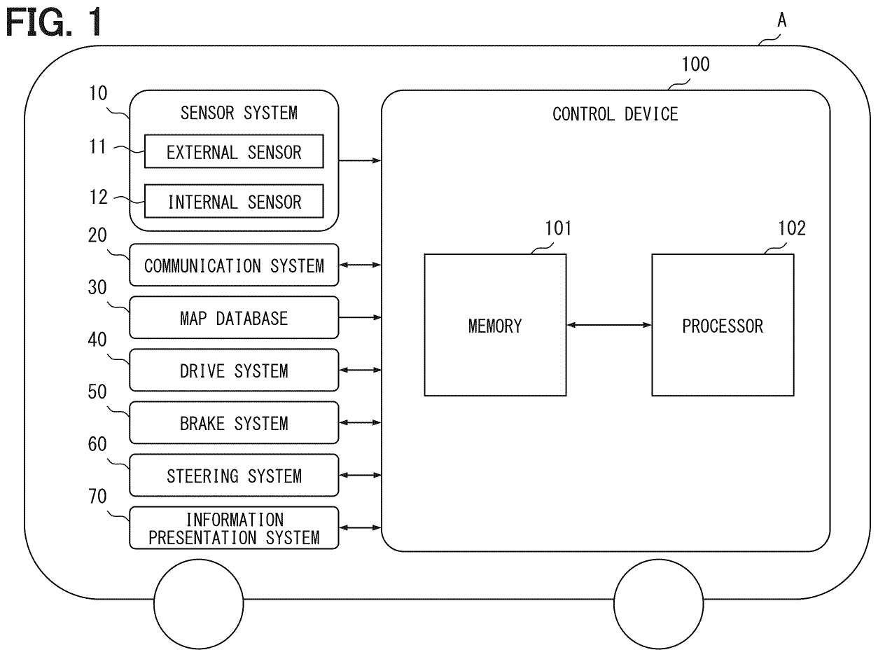

(First Embodiment) A control device 100 of a first embodiment shown in FIG. 1 controls a steering wheel 61 of a vehicle A, which serves as a host mobile body, as shown in FIG. 1. From the perspective centered on the vehicle A, the vehicle A may also be referred to as an ego-vehicle. The vehicle A is a mobile body, such as an automobile, which is configured to travel on a roadway when a user, as an occupant, is on board.

The vehicle A is an autonomous robot provided with an autonomous driving mode, which is classified into levels according to the degree of manual intervention by the user in dynamic driving tasks. The autonomous driving mode may be achieved with an automated driving control, such as conditional driving automation, advanced driving automation, or full driving automation, where the system in operation performs all dynamic driving tasks. The autonomous driving mode may also be realized by advanced driver assistance control, such as driver assistance or partial driving automation, in which the user executes a portion of the dynamic driving tasks. The autonomous driving mode may be realized by either one or combination of the automated driving control and the advanced driving assistance control or switching between the automated driving control and the advanced driving assistance control. The vehicle A may also be referred to as an autonomous vehicle. The vehicle A may be applied to a system that provides a service in which the vehicle A is dispatched to a user who wishes to board and travels by autonomous driving to the user's destination.

In the autonomous driving mode, a medium-to long-term driving plan for determining a planned travel route from the current vehicle location to the destination, and a short-term control plan for traveling along the medium-to long-term driving plan, are sequentially generated either in the vehicle A or at an external center. Autonomous driving is achieved by executing driving control in the vehicle A in accordance with each plan.

The vehicle A is equipped with a sensor system 10, a communication system 20, a map database 30, a driving system 40, a braking system 50, a steering system 60, and an information presentation system 70, as shown in FIG. 1. The sensor system 10 is configured to acquire sensor information usable by a control device 100 with respect to both the external environment and the internal environment of the vehicle A. The sensor system 10 includes an external environment sensor 11 and an internal environment sensor 12.

The external environment sensor 11 is configured to acquire external environment information as sensor information from the surroundings of the vehicle A, which constitute the external environment. The external environment sensor 11 may be of an object detection type configured to detect objects present in the external environment of the vehicle A. The object detection type external environment sensor 11 may be at least one type selected from among an external camera, LiDAR (Light Detection and Ranging/Laser Imaging Detection and Ranging), radar, and sonar.

The internal environment sensor 12 is configured to acquire internal environment information as sensor information from the internal environment of the vehicle A. The internal environment sensor 12 may be of a physical quantity detection type configured to detect specific physical quantities within the internal environment of the vehicle A. The physical quantity detection type internal environment sensor 12 includes at least one type selected from a steering angle sensor and a turning angle sensor. In this embodiment, the steering angle refers to the rotational angle of the steering wheel 61. The steering angle may also be referred to as the handle angle or the handle turning angle. The turning angle refers to the angle of tires 64 with respect to the longitudinal direction of the vehicle. The turning angle may also be referred to as the tire angle or the tire turning angle. The physical quantity detection type internal environment sensor 12 may include at least one type among a vehicle speed sensor, an acceleration sensor, and a gyro sensor.

The internal environment sensor 12 may be of a user detection type configured to detect a specific state of the user within the internal environment of the vehicle A. The user detection type internal environment sensor 12 is at least one type selected from an in-cabin camera, a seat sensor, an actuator sensor, and an in-vehicle device sensor. The seat sensor is configured to detect the seating status of the user in each seat within the vehicle interior. The actuator sensor is configured to detect the state of user instructions for the driving actuators of the vehicle A. For example, the actuator sensor detects at least one type among the operation status of the accelerator pedal, the operation status of the brake pedal, the steering status of the steering wheel, the on/off status of the ignition switch, and the shift status of the shift lever. The in-vehicle device sensor detects at least one type of user instruction status for in-vehicle devices, such as the operation status of the on/off switch, the operation status of the touch panel, and contactless recognizable gestures.

The communication system 20 is configured to acquire communication information usable by the control device 100 via wireless communication. The communication system 20 may be of a positioning type that receives positioning signals from GNSS (Global Navigation Satellite System) satellites existing outside the vehicle A. The positioning-type communication system 20 may be a GNSS receiver. The communication system 20 may also be of a V2X type that transmits and receives communication signals with a V2X system existing outside the vehicle A. The V2X-type communication system 20 may be at least one type selected from among DSRC (Dedicated Short Range Communications) device and cellular V2X (C-V2X) communication device. The communication system 20 may also be of a terminal communication type that transmits and receives communication signals with terminals existing inside the vehicle A. The terminal communication-type communication system 20 may be at least one type selected from among Bluetooth (registered trademark) devices, Wi-Fi (registered trademark) devices, and infrared communication devices.

The map database 30 stores map information that can be utilized by the control device 100. The map database 30 includes at least one type of non-transitory tangible storage medium, such as a semiconductor memory, magnetic medium, or optical medium. The map database 30 may also serve as a database for a locator configured to estimate self-state quantities, including the self-position of the vehicle A. The map database 30 may also serve as a database for a navigation unit that navigates the travel route of the vehicle A. The map database 30 may be configured by a combination of two or more types among these databases.

The map database 30 acquires and stores the latest map information, for example, through communication with an external center via a V2X-type communication system 20. Here, the map information is digitized in two or three dimensions as information representing the driving environment of the vehicle A. In particular, digital data of high-precision maps may be used as the three-dimensional map data. The map information may include road information representing at least one type among the position, shape, and surface condition of the road. The map information may include signage information representing at least one type among the position and shape of signs and lane markings associated with the road. The map information may include structure information representing at least one type among the position and shape of buildings and traffic signals facing the road.

The driving system 40 is formed of components for providing acceleration to the vehicle A. The components constituting the driving system 40 include multiple types of components such as an accelerator pedal, a drive motor, a drive engine, a start switch, a transmission, and a shift unit. The braking system 50 is composed of components for providing deceleration to the vehicle A. The components constituting the braking system 50 include multiple types of components such as the tires 64, a battery, a brake pedal, a friction braking unit, a hydraulic circuit, and a regenerative motor.

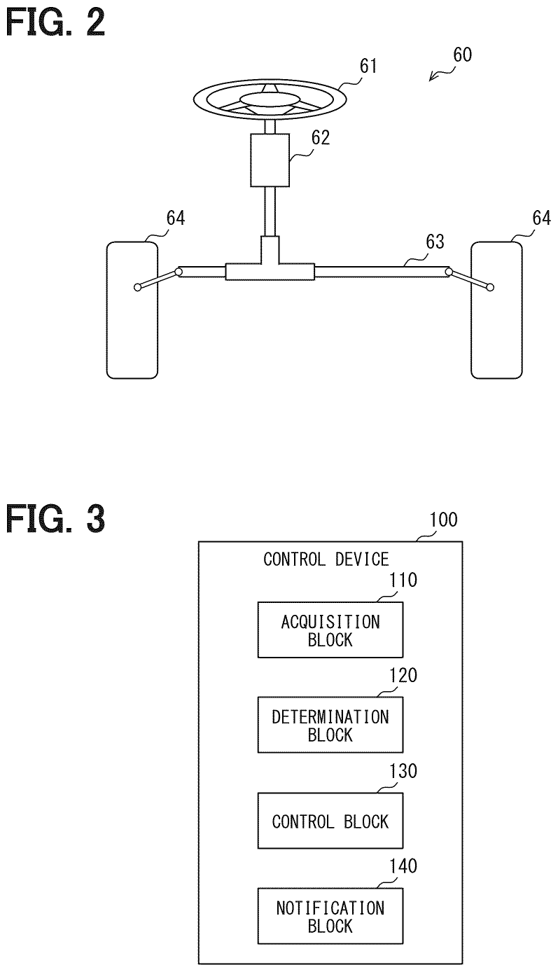

The steering system 60 shown in FIG. 2 is formed of components for providing steering to the vehicle A. The components constituting the steering system 60 include multiple types of components such as the steering wheel 61, a power steering motor 62, a turning unit 63, and the tires 64.

The steering wheel 61 is a component capable of receiving manual steering input from the user. The steering wheel 61 is pre-adjusted so that its reference angular position, which corresponds to a non-rotational state (i.e., a steering angle of zero degrees), aligns with the straight-ahead direction of the vehicle A. In other words, the correspondence between the steering angle of the steering wheel 61 and the turning angle of the tires 64 is adjusted so that the steering angle is substantially zero degrees when the steering angle is substantially zero degrees. It should be noted that the correspondence between the steering angle and the turning angle may deviate from the original state, which is a state just after the correspondence is adjusted, due to factors such as aging or wear. The correspondence between the steering angle and the turning may be readjusted at the factory during events such as battery replacement. The steering wheel 61 is an example of a steering.

The turning unit 63 operates in conjunction with the steering wheel 61 to steer the tires 64 at a turning angle corresponding to the steering angle of the steering wheel 61. In addition, the turning unit 63 is further configured to perform turning control of the tires 64 in a state where the linkage between the tires 64 and the steering wheel 61 is disconnected. The steering wheel 61 and the turning unit 63 may be connected to each other to enable connected operation through a shaft configured to mechanically transmit the rotation of the steering wheel 61. Alternatively, the steering wheel 61 and the turning unit may be connected to each other to enable connected operation through a so-called steer-by-wire system, in which the rotation of the steering wheel 61 is electrically transmitted through a wire harness.

The information presentation system 70 is configured to present notification information to the user of the vehicle A. The information presentation system 70 may be of a visual stimulus type that stimulates the user's sense of sight. The visual stimulus type information presentation system 70 is at least one type selected from a HUD (Head-Up Display), MFD (Multi-Function Display), combination meter, navigation unit, and light-emitting unit. The information presentation system 70 may also be of an auditory stimulus type that stimulates the user's sense of hearing. The auditory stimulus type information presentation system 70 is at least one type selected from a speaker, buzzer, and vibration unit. The information presentation system 70 may also be of a tactile stimulus type that stimulates the user's sense of touch. The tactile sensations stimulated by the tactile stimulus type information presentation system 70 include at least one type selected from the sense of touch, the sense of temperature, and the sense of airflow. The tactile stimulus type information presentation system 70 is at least one type selected from a vibration unit of the steering wheel, a vibration unit of the driver's seat, a reaction force unit of the steering wheel, a reaction force unit of the accelerator pedal, a reaction force unit of the brake pedal, and an air conditioning unit.

The visual stimulus type information presentation system 70 may also include a device configured to present information to a user outside the vehicle, such as an external display unit. The auditory stimulus type information presentation system 70 may also include a device configured to present information to a user outside the vehicle, such as an external speaker.

The control device 100 is connected to the sensor system 10, the information presentation system 70, and the map database 30 via at least one type of connection selected from a LAN (Local Area Network) line, a wire harness, an internal bus, and a wireless communication line. The control device 100 includes at least one dedicated computer.

The dedicated computer constituting the control device 100 may be an integrated ECU (Electronic Control Unit) that integrates the driving control of the vehicle A. The dedicated computer constituting the control device 100 may be a determination ECU that determines the driving tasks in the driving control of the vehicle A. The dedicated computer constituting the control device 100 may be a monitoring ECU that monitors the driving control of the vehicle A. The dedicated computer constituting the control device 100 may be an evaluation ECU that evaluates the driving control of the vehicle A.

The dedicated computer constituting the control device 100 may be a steering control ECU specialized in the control of the steering system 60. The dedicated computer constituting the control device 100 may be a navigation ECU that navigates the travel route of the vehicle A. The dedicated computer constituting the control device 100 may be a locator ECU that estimates the self-state quantities of the vehicle A. The dedicated computer constituting the control device 100 may be an actuator ECU that controls the driving actuators of the vehicle A. The dedicated computer constituting the control device 100 may be an HCU (HMI [Human Machine Interface] Control Unit) that controls information presentation by the information presentation system 70 in the vehicle A. The dedicated computer constituting the control device 100 may be a computer other than the vehicle A, such as an external center or mobile terminal capable of communicating with the vehicle A.

The dedicated computer constituting the control device 100 includes at least one memory 101 and at least one processor 102. The memory 101 is at least one type of non-transitory tangible storage medium, which non-transitorily stores computer-readable programs and data. Examples of the non-transitory tangible storage medium include semiconductor medium, magnetic medium, and optical medium. Here, “storage” may refer to accumulation in which data is retained even when the vehicle A is powered off, or it may refer to temporary storage in which data is erased when the vehicle A is powered off. The processor 102 includes at least one type of core, such as a CPU (Central Processing Unit), GPU (Graphics Processing Unit), RISC-CPU (Reduced Instruction Set Computer CPU), CISC-CPU (Complex Instruction Set Computer CPU), DFP (Data Flow Processor), or GSP (Graph Streaming Processor).

In the control device 100, the processor 102 executes instructions included in a control program stored in the memory 101, which serves as a storage medium, to control the steering wheel of the vehicle A. As a result, the control device 100 constructs functional blocks for controlling the steering wheel of the vehicle A. The functional blocks constructed in the control device 100 include, as shown in FIG. 3, an acquisition block 110, a determination block 120, a control block 130, and a notification block 140.

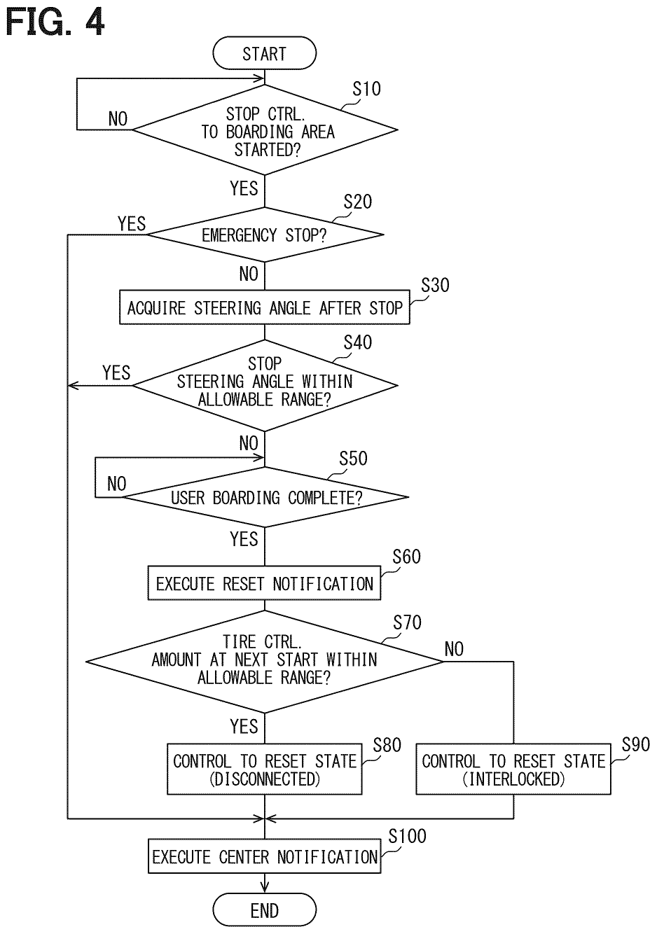

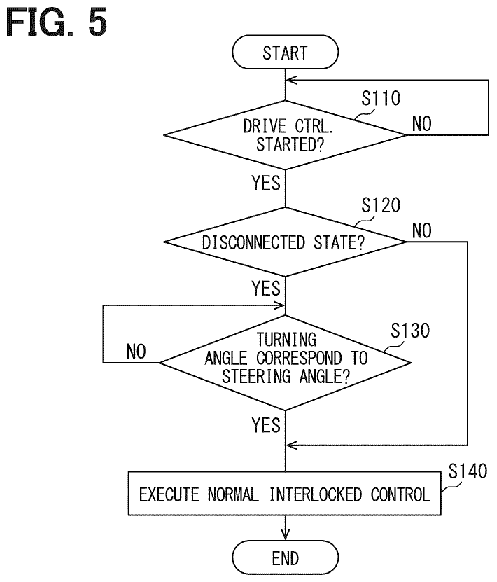

Through the cooperation of these blocks 110, 120, 130, and 140, the control method by which the control device 100 controls the steering wheel of the vehicle A is executed according to the control flows shown in FIGS. 4 and 5. First, the control flow when the vehicle A stops will be described below with reference to FIG. 4. The control flow shown in FIG. 4 is repeatedly executed while the vehicle A is active, especially during driving. It should be noted that each “S” in the control flow represents a respective step executed by multiple instructions included in the control program.

First, in step S10, the determination block 120 determines whether stop control for a boarding area by autonomous driving has been started. Here, the boarding area refers to an area where a user is expected to board the vehicle A after the vehicle A has stopped. The boarding area includes at least one type of area such as a boarding zone prepared for users who use the service to get on and off the vehicle A, a parking lot for parking the vehicle A, an area around the user waiting to board, or simply an area set as the destination for autonomous driving.

The determination block 120 determines that the stop control has been started, for example, when a travel trajectory to the boarding area, as an end position, in a short-term control plan for autonomous driving has been generated, or when vehicle control according to the travel trajectory has been started. Alternatively, the determination block 120 may determine that the stop control has been started when the approach of the vehicle A within a predetermined distance range to the boarding area is detected.

Next, in S20, the determination block 120 determines whether the stop control is being executed for an emergency stop. The emergency stop refers to a stop executed by MRM (Minimum Risk Maneuver) control by the autonomous driving ECU, for example, when an event occurs that makes safe driving impossible. Alternatively, the emergency stop may be a stop executed by brake control when the user in the driver's seat performs an override operation of the braking system 50. The override operation may be depressing the brake pedal. When it is determined that the stop control is executed for the emergency stop, this flow ends. That is, when the stop control is executed for the emergency stop, a reset control by the control block 130, which will be described later, is not performed.

When it is determined in S20 that the stop control is not executed for the emergency stop, this flow proceeds to S30. In S30, the acquisition block 110 acquires a stop steering angle of the steering wheel 61 after the vehicle has stopped. The stop steering angle is the steering angle when the stop control completes. For example, when the acquisition block 110 detects completion of the stop control based on the vehicle speed of the vehicle A becoming substantially zero at the end of the travel path to the boarding area, the acquisition block 110 acquires the steering angle detected by the steering angle sensor included in the internal environment sensor 12 as the stop steering angle.

In the subsequent S40, the determination block 120 determines whether the acquired stop steering angle falls within an allowable angle range. The allowable angle range is the range of steering angles between the lower threshold value, inclusive or exclusive, and the upper threshold value, inclusive or exclusive. The allowable angle range includes at least the steering angle when the vehicle A travels straight. The positive and negative values of the steering angle are defined by the rotational direction of the steering wheel. Which of the rightward or leftward rotational directions is defined as the positive direction may be determined arbitrarily. The steering wheel at the steering wheel angle corresponding to the straight-ahead direction of the vehicle A may also be referred to as the steering wheel at an initial position. The upper and lower threshold values for the allowable steering angle range may be set according to the magnitude of the expected error in the steering angle relative to the tire angle and the required margin. When it is determined that the stop steering angle falls within the allowable angle range, this process ends. That is, when it is determined that the stop steering angle falls within the allowable angle range, the reset control, which will be described later, by the control block 130 is not performed.

When it is determined that the stop steering angle falls outside the allowable angle range, this process proceeds to S50. In S50, the determination block 120 determines whether the user has completed boarding the vehicle A. The determination block 120 may determine whether the user has completed boarding based on sensor information from the internal environment sensor 12 of the user detection type. In addition, in this embodiment, the determination block 120 further determines which seat in the vehicle A the user has sit in.

When it is determined that the user has completed boarding, this process proceeds to S60. In S60, the notification block 140 executes a reset notification via the information presentation system 70. The reset notification is a notification that presents control information related to the reset control described later. By executing the reset notification to the vehicle interior (i.e., the user in the vehicle A), the notification block 140 makes the user, after boarding the vehicle A, aware that the steering wheel 61 will rotate while the vehicle stops.

Through the reset notification, the notification block 140 presents at least one type of information, such as execution notification information of the reset control, steering angle notification information related to the steering angle, or tire angle notification information related to the tire angle. The execution notification information is information that indicates the control of the steering wheel to the reset state will be performed. The steering angle notification information is information that presents the current steering angle during the execution of the reset control. The tire angle notification information is information that presents the current tire angle during the execution of the control. The notification block 140 may present the reset notification via the information presentation system 70 of the visual stimulus type. The notification block 140 may present the reset notification using a combination of the information presentation system 70 of the visual stimulus type and the information presentation system 70 of the auditory stimulus type. The reset notification may be continuously executed until the control to the reset state is completed.

It should be noted that the notification block 140 executes the reset notification to the user sits in the driver seat. Specifically, the notification block 140 executes the reset notification when the boarded user sits in the driver seat, and does not execute the reset notification when there is no user in the driver seat.

In the subsequent S70, the determination block 120 determines whether a control amount of the tire necessary for starting the vehicle A after the stop control falls within an allowable control range. The control amount of the tire is the amount of change in the turning angle during steering control in a predetermined period from the start of vehicle movement. The amount of change is measured from the point when the stop control is completed. The amount of change in the turning angle may be the cumulative amount of turning angle change during the predetermined period, or the amount of change may be the difference between the turning angle at the start and at the end of the predetermined period.

Here, the allowable control range may be a range of tire control amounts from the lower threshold value, inclusive or exclusive. The lower threshold value is a threshold that correlates with the amount of change in the turning angle from when the reset control completes, when the reset control is performed in a state in which the steering wheel 61 and the tires 64 are connected. That is, the determination block 120 determines how much greater the amount of change in the turning angle is when the turning angle when the stop control completes is maintained until the vehicle A starts, compared to the amount of change in the turning angle when the turning angle is reset before the vehicle A starts.

When the control amount of the tire is determined to fall within the allowable control range, this flow proceeds to S80. In S80, the control block 130 executes control to reset the steering wheel 61 to the reset state (i.e., the reset control). In the reset control, the control block 130 controls for the steering wheel 61 to return the stop steering angle to a specified steering angle within the allowable angle range. In this step, the control block 130 disconnects the linkage between the steering wheel 61 and the tires 64 during the reset control. In other words, during the reset control in this step, the control block 130 prohibits the turning of the tires 64. Accordingly, the turning angle after the reset control remains the same as the turning angle at the time when the stop control is completed. The control block 130 continues the state in which the linkage between the steering wheel 61 and the tires 64 is disconnected until the processing of S140 in FIG. 5, which will be described later, is executed.

On the other hand, when it is determined in S70 that the control amount of the tire falls outside the allowable control range, this flow proceeds to S90. In S90, the control block 130 executes the reset control. In this step, the control block 130 executes the reset control while maintaining the linkage between the steering wheel 61 and the tires 64. In other words, during the reset control in this step, the control block 130 allows the turning of the tires 64. Accordingly, after the reset control in this step, the turning angle falls within the allowable angle range. Ideally, after the reset control in this step, the turning angle corresponds to the straight-ahead direction of the vehicle A (i.e., substantially zero degrees). It should be noted that the control block 130 continues to maintain the connected state between the steering wheel 61 and the tires 64 even after this process.

In S100, which follows S80 or S90, the notification block 140 performs a center notification to the center via the communication system 20. The center notification includes at least one type of information, such as the angle information from the turning angle sensor after the reset control, the steering angle information of the steering wheel 61, and information regarding the presence or absence of abnormalities in the power steering motor 62. In other words, the center notification is a notification of information related to the content of the executed reset control. The notification block 140 transmits the center notification as information containing smaller amount of information (i.e., smaller data) than the stop notification, which is a notification of information related to the content of the stop control. Here, the amount of information refers to at least one of the volume of communication and the type of information. The stop notification includes at least one type of information, such as a position at which the vehicle A stops, whether the stop is successful, whether the vehicle speed is zero, whether the door lock is in the ON state, and whether the engine hood is closed.

Next, the control processing of the steering wheel 61 executed when the vehicle A starts moving will be described with reference to the flowchart in FIG. 5. First, in S110, the determination block 120 determines whether a start control of the vehicle A has been initiated.

The determination block 120 determines that the start control has been initiated, for example, when a travel trajectory is generated in a short-term control plan for autonomous driving with the boarding area as the starting point after the stop control has been completed, or when vehicle control according to the travel trajectory has been started. Alternatively, the determination block 120 may determine that the start control has been initiated when the boarding user gives a command to the vehicle A to start moving. It should be noted that in the start control, the turning control of the tires 64 is executed regardless of whether the tires 64 and the steering wheel 61 are in a connected or in a disconnected state. That is, in the turning control in the disconnected state, the tires 64 are turned independently of the stationary steering wheel 61 until the processing of S140, described later, is executed.

In the subsequent S120, the determination block 120 determines whether the linkage between the steering wheel 61 and the tires 64 is disconnected. In other words, the acquisition block 110 determines which control has been executed, the reset control in the disconnected state with the tires 64 in S80, or the reset control in the connected state with the tires 64 in S90.

If it is determined that the linkage between the steering wheel 61 and the tires 64 is disconnected, the flow proceeds to S130. In S130, the determination block 120 determines whether the turning angle controlled in the start control matches the steering angle (the specified steering angle). In other words, when the tire angle under the turning control of the tires in the disconnected state with the steering wheel 61 is converted to the steering angle, the determination block 120 determines whether the converted steering angle substantially matches the current steering angle. The determination process in S130 is repeatedly executed until an affirmative determination is made.

When it is determined in S120 that it is not in the disconnected state, or when it is determined in S130 that the tire angle matches the steering angle, the flow proceeds to S140. In S140, the control block 130 executes control of the steering wheel 61 by normal connected control. The normal connected control is control in which the tires 64 and the steering wheel 61 are connected, and the steering angle of the steering wheel 61 with respect to the turning angle of the tires 64 has a normal correspondence.

Through the series of processes in S130 and S140, when the vehicle A starts moving while the tires 64 and the steering wheel 61 are disconnected, the steering wheel 61 will remain stationary without being driven until the turning angle and the steering angle correspond to each other. For example, suppose the tires 64 are stopped on the shoulder of the road in a state tilted to the left with respect to the straight-ahead direction, and the steering wheel 61 is reset by the reset control in the disconnected state. When the vehicle A in this state executes the start control to enter the right lane from the shoulder, the tires 64 will first begin turning from left to right independently of the stationary steering wheel 61. When the tires 64 eventually face the straight-ahead direction, the tires 64 and the steering wheel 61 begin to operate in the connected state. From the moment the connected state begins, the steering wheel 61 starts to rotate to the right together with the tires 64.

According to the first embodiment described above, the steering wheel 61 is controlled such that the stop steering angle, which is the steering angle after the stop control to the boarding area completes by autonomous driving, falls within the allowable angle range including the steering angle when the vehicle A travels straight. Thus, for the user who boards the vehicle A, the vehicle A will start with the steering wheel 61 in the reset state within the allowable angle range. Accordingly, any sense of discomfort the user may feel regarding the steering angle of the steering wheel 61 can be suppressed.

Further, according to the first embodiment, the steering wheel 61 is controlled to the reset state after the stop control completes with the steering wheel outside the allowable angle range. As a result, the reset control of the steering wheel 61 is not executed while the vehicle A is moving, and the reset control of the steering wheel 61 is executed after the vehicle A has stopped. Accordingly, in cases where a user is already onboard, it is possible to avoid causing any sense of discomfort to the user due to the movement of the steering wheel 61 before the vehicle A stops.

In addition, according to the first embodiment, when the stop steering angle when the stop control completes falls within the allowable angle range, the reset control is not executed. Accordingly, unnecessary operation of the steering wheel 61 can be avoided in cases where the reset control is not required.

Furthermore, according to the first embodiment, control to the reset state is initiated after the user has completed boarding following the completion of the stop control. Thus, the user can recognize the reset control of the steering wheel 61 after boarding. Accordingly, the user can easily perceive the elimination of any discomfort.

Further, according to the first embodiment, when the user sits in the driver seat, the control to the reset state is notified within the vehicle cabin, whereas when the user does not sit in the driver seat, notification within the vehicle cabin is not performed. Thus, a user who is paying attention to the operation of the steering wheel 61 is reliably notified that the steering wheel 61 will move, while a user who are not can avoid unnecessary notifications.

In addition, according to the first embodiment, the linkage between the steering wheel 61 and the tires 64 is disconnected during the reset control. Thus, during the reset control, deterioration of the tires 64 due to turning movement of the tires 64 can be suppressed.

Furthermore, according to the first embodiment, when the control amount of the tires 64 necessary for starting the vehicle A after the stop control falls outside the allowable control range, disconnection of the linkage between the steering wheel 61 and the tires 64 is not performed. Thus, in cases where disconnection of the linkage would lead a relatively large change in the turning angle during the start control, the connection between the steering wheel 61 and the tires 64 are kept for easier start control.

Moreover, according to the first embodiment, after the vehicle A starts moving, the driving of the steering wheel 61 is stopped until the turning angle of the tires 64 and the steering angle of the steering wheel 61 correspond to each other. As a result, it is possible to avoid driving the steering wheel 61 solely for adjusting the steering angle corresponding to the turning angle of the tires 64. Thus, the sense of discomfort experienced by the user due to the movement of the steering wheel 61 when the vehicle A starts can be reduced.

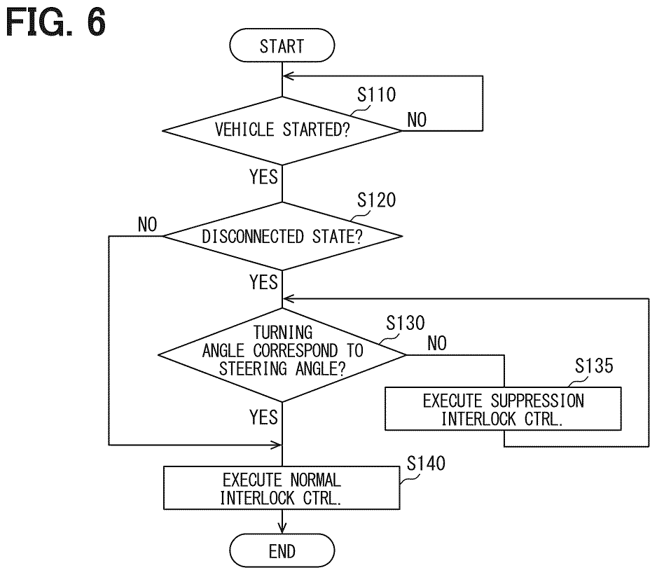

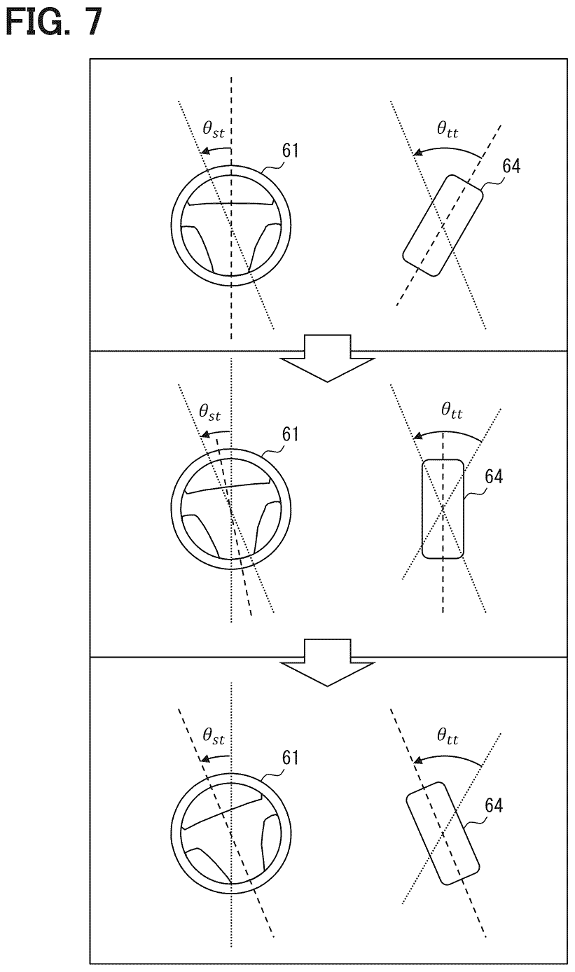

(Second Embodiment) As shown in FIGS. 6 and 7, a second embodiment is a modification of the first embodiment. In the second embodiment, the control process for the steering wheel 61 executed when the vehicle A starts is different from that of the first embodiment.

In the second embodiment, when it is determined in S130 that the steering angle and the turning angle do not match each other, the flow proceeds to S135 as shown in FIG. 6. In S135, the control block 130 executes control of the steering wheel 61 through reduced-ratio connection control (or suppression-interlock control). The reduced-ratio connection control is a control in which the tires 64 and the steering wheel 61 are connected, but the rate of change of the steering angle with respect to the amount of change in the turning angle is reduced compared to the normal connected control. The reduced-rate connection control is continuously executed until it is determined that the turning angle and the steering angle match each other.

Through the series of processes S130, S135, and S140, when the vehicle A starts moving while the linkage between the steering wheel 61 and the tires 64 is disconnected, the rotational speed of the steering wheel 61 with respect to the target steering angle is suppressed until the turning angle matches the steering angle, compared to the rotational speed when the turning angle matches the steering angle.

For example, at the start of the start control, suppose that the target turning angle θₜₜ of the tires 64 and the target steering angle θₛₜ, which is smaller than the target turning angle θₜₜ, are set as shown in the upper part of FIG. 7. In this case, the reduced-ration connection control is executed so that the time it takes for the tires 64 at the start of the start control to reach the target turning angle θₜₜ substantially matches the time it takes for the steering wheel 61 at the start of the start control to reach the target steering angle θₛₜ. When the target steering angle θₛₜ is large with respect to the target turning angle θₜₜ, the rotation of the steering wheel 61 is slow, and thus, the time required to reach the target turning angle θₜₜ does not match with the time required to reach the target steering angle θₛₜ. Thus, the reduced-ration connection control will continue to a control cycle in which the target steering angle θₛₜ becomes smaller relative to the target turning angle θₜₜ.

According to the second embodiment described above, after the vehicle A starts, the driving of the steering wheel 61 is suppressed until the turning angle of the tires 64 and the steering angle of the steering wheel 61 correspond to each other. As a result, it is possible to prevent the steering wheel 61 from moving at a relatively high speed in order for the steering angle to match the turning angle of the tires 64. Thus, the sense of discomfort experienced by the user due to the movement of the steering wheel 61 when the vehicle A starts can be reduced.

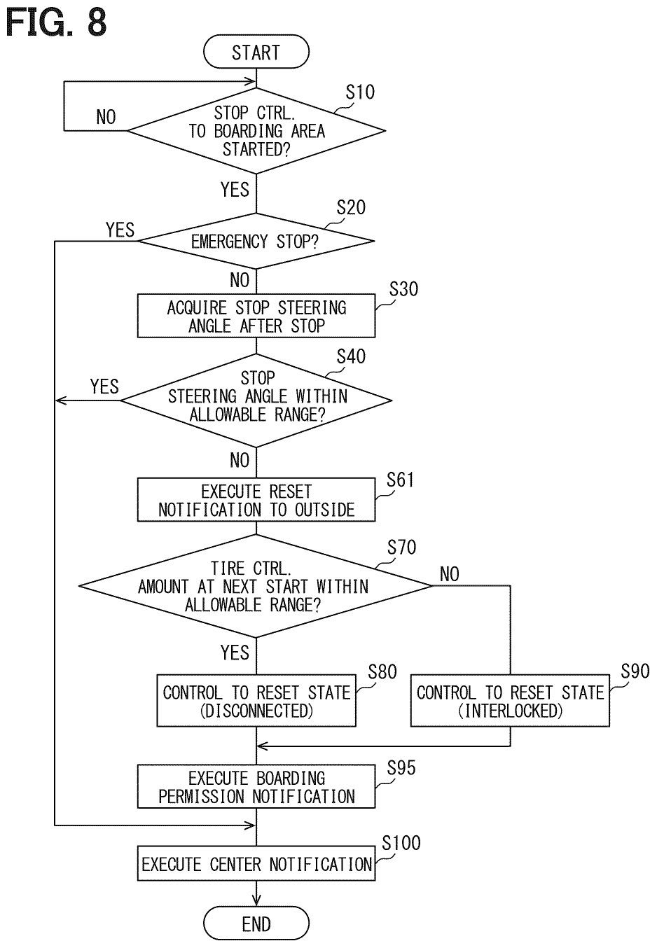

(Third Embodiment) As shown in FIG. 8, a third embodiment is a modification of the first embodiment. In the third embodiment, the control processing of the steering wheel 61 executed when the vehicle A stops differs from that of the first embodiment.

In the third embodiment, when it is determined in S40 that the stop steering angle falls outside the allowable angle range, the flow proceeds to S61 as shown in FIG. 8. In S61, the notification block 140 executes a reset notification without waiting for the user to board, that is, while the user is outside the vehicle. In this embodiment, the notification block 140 provides the reset notification via the information presentation system 70, which presents information to the outside of the vehicle (i.e., the user outside the vehicle). The reset notification is continuously executed until control to the reset state is completed. When the reset notification becomes active in S61, the flow proceeds to S70.

In S95, following S80 or S90, the notification block 140 issues a boarding permission notification via at least one of the communication system 20 and the information presentation system 70 after the reset control completes. The boarding permission notification is a notification that informs the user that boarding of the vehicle A is permitted. After the processing in S95, the flow proceeds to S100. Through the series of processes in S61, S70, S80, S90, and S95, the reset control is executed before the user boards the vehicle A.

According to the third embodiment described above, after the stop control completes, control of the steering wheel 61 is initiated, and the control of the steering wheel 61 is completed before the user boards the vehicle. Thus, at the time the user boards the vehicle, any sense of discomfort regarding the steering angle of the steering wheel 61 can already be reduced. Accordingly, the user's sense of discomfort can be further reduced.

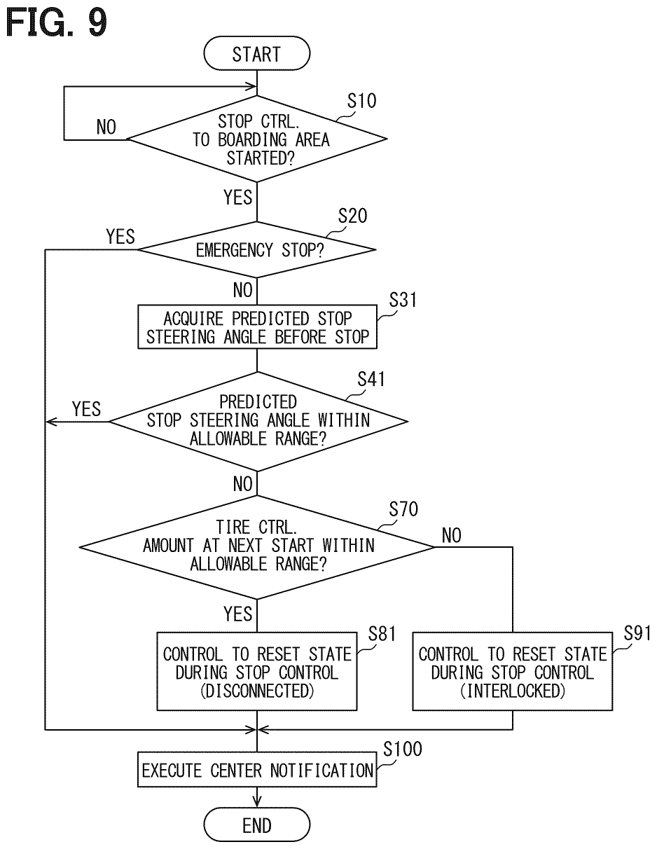

(Fourth Embodiment) As shown in FIG. 9, a fourth embodiment is a modification of the first embodiment. In the fourth embodiment, the control processing of the steering wheel 61 executed when the vehicle A is stopped differs from that of the first embodiment.

In the fourth embodiment, when it is determined in S20 that the stop control is not being executed for the emergency stop, the flow proceeds to S31 as shown in FIG. 9. In S31, the acquisition block 110 acquires a predicted steering angle of the steering wheel 61 before the vehicle stops. The predicted stop steering angle is the steering angle that is predicted before the stop control completes. The acquisition block 110 may acquire the predicted stop steering angle, for example, by predicting a predicted stop steering angle that correlates with the scheduled stop position and posture by the stop control, as well as the current position and posture of the vehicle A relative to the scheduled stop position.

In S41, which follows S31, the determination block 120 determines whether the acquired predicted stop steering angle falls within the allowable angle range. When it is determined that the predicted stop steering angle falls outside the allowable angle range, the flow proceeds to S70. It should be noted that, in S70 of this embodiment, the tire control amount is the amount of change in the steering angle from the predicted stop steering angle after the stop control completes when the reset control is performed in the disconnected state where the linkage with the tires 64 is disconnected. The determination process in S70 is executed during the stop control, that is before the vehicle A stops. When it is determined in S70 that the tire control amount necessary for starting the vehicle after the stop control falls within the allowable control range, the flow proceeds to S81. When it is determined that the tire control amount falls outside the allowable control range, the flow proceeds to S91.

In S81, the control block 130 executes the reset control during the stop control. In this step, the control block 130 executes the reset control in a state where the linkage with the tires 64 under turning control for stopping the vehicle A is disconnected. In other words, the reset control in this step is executed independently of the turning control of the tires 64 under the stop control.

On the other hand, in S91, the control block 130 executes the reset control while maintaining the linkage with the tires 64. In other words, the reset control in this step is executed in coordination with the turning control of the tires 64 under the stop control. That is, in the stop control of this step, the control plan to stop the vehicle A is generated with the condition that the steering wheel 61 is also in the reset state. After each process in S81 and S91, this flow proceeds to S100.

According to the fourth embodiment described above, the steering wheel 61 is controlled to the reset state by the stop control completes so that the steering angle falls within the allowable angle range when the stop control completes. Thus, when the stop control completes, the steering wheel 61 is already in the reset state. Accordingly, the waiting time before or after the user's boarding can be reduced.

(Other Embodiments) As described above, several embodiments have been explained; however, the present disclosure is not to be interpreted as being limited to these embodiments, and various other embodiments and combinations may be applied without departing from the gist of the present disclosure.

In a modified example, the control device 100 may change the accuracy of the reset control according to the situation. Here, the accuracy of the reset control refers to the allowable angle range. The higher the accuracy, the smaller the allowable angle range is. For example, the control device 100 changes the accuracy of the reset control according to the estimated time until the user boards the vehicle A after the stop control completes. The estimated time may be predicted according to the type of boarding area where the vehicle is stopped.

As one example, when the boarding area is a parking lot, the estimated time is expected to be longer than when it is another type, such as a pick-up/drop-off area. The control device 100 increases the accuracy of the reset control as the estimated time becomes longer. In this case, in S40, the determination block 120 performs the determination process using different allowable angle ranges according to the type of boarding area, and in S80 and S90, the control block 130 executes the reset control corresponding to the different allowable angle ranges according to the type of boarding area. Alternatively, the control device 100 may vary the accuracy of the reset control according to the size of the space for stopping the vehicle A in the boarding area or the presence or absence of road surface markings defining the space.

In a modified example, the notification block 140 may provide the reset notification in S60 in a manner corresponding to the seat on which the user is seated. For example, when the user is seated in the driver seat, the notification block 140 may provide the reset notification via both the visual and auditory information presentation systems 70, whereas when the user is seated in the front passenger seat or rear seat, the reset notification may be provided only via the auditory information presentation system 70. Alternatively, the notification block 140 may provide the reset notification in the same manner regardless of the seat in which the user is seated.

In a modified example, the control block 130 may set the steering speed of the steering wheel 61 to a slower speed during the reset control in S80, S90, compared to that used in the normal steering control. Specifically, the control block 130 may execute the reset control at a steering speed that is lower than the lower limit of the steering speed expected when controlling the steering wheel 61 within the allowable angle range during normal driving.

In a modified example, the control block 130 may execute the reset control, which is performed before the user boards as in S80 and S90 in FIG. 8, prior to other movement controls of the steering wheel 61. Specifically, in a vehicle A having a function to move the steering wheel 61 to a farther and higher position of the driver's seat after stopping, the control block 130 may be configured to execute the reset control before performing this function.

In a modified example, the notification block 140 may also perform the reset notification to the outside of the vehicle in S60. Further, in S61, the notification block 140 may also perform the reset notification to the interior of the vehicle.

In a modified example, in S135, the control block 130 may be configured to execute the reduced-ratio connection control when the target steering angle θₛₜ is smaller than the target turning angle θₜₜ.

In a modified example, the control device 100 may be applied to a type of vehicle A that is capable of transporting a user who is not seated on a seat. Specifically, the control device 100 may be applied to a vehicle A, such as an autonomous bus, in which users can stand while riding.

In a modified example, the dedicated computer constituting the control device 100 may include at least one of a digital circuit and an analog circuit as a processor. Here, the digital circuit refers to at least one type among, for example, an ASIC (Application Specific Integrated Circuit), FPGA (Field Programmable Gate Array), SoC (System on a Chip), PGA (Programmable Gate Array), and CPLD (Complex Programmable Logic Device). Such digital circuits may also include a memory for storing programs.

In a modified example, the vehicle A to which the control device 100 is applied may be an autonomous driving robot that can transport cargo or collect information through autonomous or remote driving, and is also configured to allow manual operation via a steering member. In addition to the explanation forms up to this point, the above-described embodiments and modified examples may be implemented as a control device, which is configured to be mountable on the vehicle A and includes at least one processor 102 and at least one memory 101, in the form of a processing circuit (for example, a processing ECU) or a semiconductor device (for example, a semiconductor chip).

1. A control device configured to control a steering of a vehicle that is configured perform autonomous driving, the control device comprising:
a processor configured to:
acquire a steering angle of the steering during the autonomous driving; and
when the vehicle is autonomously stopped under a stop control at a boarding area and a stop steering angle of the steering after the stop control completes falls outside an allowable angle range including the steering angle when the vehicle travels straight, perform a reset control for the steering to return the stop steering angle to a specified steering angle within the allowable angle range, wherein
the processor is further configured to disconnect a linkage between the steering and a tire when performing the reset control.

2. The control device according to claim 1, wherein
the processor is configured not to perform the reset control when the stop steering angle falls within the allowable angle range.

3. The control device according to claim 1, wherein
the processor is configured to start performing the reset control after the stop control completes and then a user boards the vehicle.

4. The control device according to claim 3, wherein
the processor is further configured to:
notify the user in a vehicle cabin of the vehicle of a control to the reset state when the user sits in a driver seat of the vehicle; and
not notify the user of the control when the user does not sit in the driver seat.

5. The control device according to claim 1, wherein
the processor is configured to:
start performing the reset control after the stop control completes; and then
complete the reset control before a user boards the vehicle.

6. The control device according to claim 1, wherein
the processor is further configured to notify a user outside the vehicle of a control to the reset state.

7. The control device according to claim 1, wherein
the processor is further configured to notify a user in a vehicle cabin of the vehicle of control information regarding control of the steering while performing the reset control.

8. The control device according to claim 1, wherein
the processor is further configured to notify a center of control information regarding a control of the steering, and
the control information has a smaller data amount than stop information regarding the stop control.

9. The control device according to claim 1, wherein
the processor is further configured not to disconnect the linkage between the steering and the tire when a control amount of the tire necessary for starting the vehicle after the stop control falls outside an allowable control range.

10. The control device according to claim 1, wherein
the specified steering angle of the steering after performing the reset control does not match a turning angle of the tire,
the turning angle of the tire changes with the steering at the specified steering angle when the vehicle starts from the boarding area under the autonomous driving, and
the processor is configured to start controlling the steering when the turning angle of the tire matches the specified steering angle of the steering.

11. The control device according to claim 1, wherein
the specified steering angle of the steering after performing the reset control does not match a turning angle of the tire, and
the processor is further configured to control the steering more gently than the tire after the vehicle starts from the boarding area under the autonomous driving until the turning angle of the tire matches the steering angle of the steering.

12. A control method executed by a processor to control a steering of a vehicle that is configured to perform autonomous driving, the control method comprising:
acquiring a steering angle of the steering the autonomous driving; and
when the vehicle is autonomously stopped under a stop control at a boarding area and a stop steering angle of the steering after the stop control completes falls outside an allowable angle range including the steering angle when the vehicle travels straight, performing a reset control for the steering to return the stop steering angle to a specified steering angle within the allowable angle range, wherein
the processor is further configured to disconnect a linkage between the steering and a tire when performing the reset control.

13. A computer readable non-transitory storage medium comprising a control program including instructions for controlling a steering of a vehicle that is configured to perform autonomous driving, the instructions configured to, when executed by a processor, cause the processor to:
acquire a steering angle of the steering during the autonomous driving; and
when the vehicle is autonomously stopped under a stop control at a boarding area and a stop steering angle of the steering after the stop control completes falls outside an allowable angle range including the steering angle when the vehicle travels straight, perform a reset control for the steering to return the stop steering angle to a specified steering angle within the allowable angle range, wherein
the processor is further configured to disconnect a linkage between the steering and a tire when performing the reset control.
